(19) United States
(12) Patent Application Publication
(10) Pub. No.: US 2022/0322699 A1
(43) Pub. Date: Oct. 13, 2022

(54) Meat-Like Food Product and Method for Producing Meat-Like Food Product

(71) Applicant: MORINAGA MILK INDUSTRY CO., LTD., Tokyo (JP)

(72) Inventor: Sachiko Takahashi, Zama-shi (JP)

(73) Assignee: MORINAGA MILK INDUSTRY CO., LTD., Tokyo (JP)

(21) Appl. No.: 17/704,292

(22) Filed: Mar. 25, 2022

(30) Foreign Application Priority Data
Mar. 30, 2021 (JP) 2021-056494

(51) Int. Cl. A23J 3/16; A21D 6/00; A21D 2/26; A23J 3/22; A21D 2/16

(52) U.S. Cl. CPC A23J 3/16; A21D 6/003; A21D 2/266; A23J 3/227; A21D 2/165

(57) ABSTRACT

A method for producing a meat-like food product comprises the steps of: mixing ingredients comprising tofu, water-soluble dietary fibers derived from grain, and gluten to prepare a dough; shaping the dough into a shaped product; and heating the shaped product.

### BACKGROUND OF THE INVENTION

### Field of the Invention

The present invention relates to a meat-like food product and a method for producing the same.

This application claims the benefit of priority from Japanese Patent Application No. 2021-056494, filed Mar. 30, 2021, the entire contents of which are incorporated herein by reference.

### Background Art

A market for meat-like food products, which use an ingredient(s) other than meat and yet have a texture similar to that of a food product using meat as an ingredient, is growing these days.

Many meat-like food products that use soy flour as an ingredient are available commercially. Such meat-like food products have a strong soybean flavor. On the other hand, meat-like food products that use tofu as an ingredient have the advantage of weak or acceptable soybean flavor, enabling easy combination with other ingredient(s).

Japanese Patent Laid-Open Publication No. 2020-28246 discloses, in the working examples, a meat-like food product obtained by putting a mixture of a dewatered firm tofu, a soybean-derived protein and a salad oil into a bag of vinylidene chloride, and heating the mixture with steam.

### SUMMARY OF THE INVENTION

However, the meat-like food product obtained by the method described in Japanese Patent Laid-Open Publication No. 2020-28246 does not have a satisfactory meat-like texture. The present invention provides a meat-like food product having an excellent meat-like texture.

Embodiments of the present invention relate to the following.

[1] A method for producing a meat-like food product including the steps of: mixing ingredients including tofu, water-soluble dietary fibers derived from grain, and gluten to prepare a dough; shaping the dough into a shaped product; and heating the shaped product.
[2] The method for producing a meat-like food product as described in [1], in which the water-soluble dietary fibers derived from grain are water-soluble dietary fibers of at least one selected from the group consisting of oat bran, barley, and rye.
[3] The method for producing a meat-like food product as described in [1] or [2], in which the ratio of the total mass of the solid content of the water-soluble dietary fibers derived from grain to the total mass of the solid content of the tofu is not more than 20, and the ratio of the total mass of the solid content of the gluten to the total mass of the solid content of the tofu is less than 4.8.
[4] The method for producing a meat-like food product as described in any one of [1] to [3], in which the ingredients further include at least one selected from the group consisting of corn flour, konjac, brown rice flour, potato flakes, pea flour, and soy flour.
[5] The method for producing a meat-like food product as described in any one of [1] to [4], in which the ingredients further include a fat or oil which is liquid at room temperature.
[6] The method for producing a meat-like food product as described in any one of [1] to [5], in which the step of preparing the dough includes preparing a first dough and also preparing a second dough whose composition differs from that of the first dough, and in which the shaping step includes wrapping the first dough in the second dough to form the shaped product.
[7] The method for producing a meat-like food product as described in any one of [1] to [6], in which the heating step includes frying the shaped product in oil.
[8] A cooked meat-like food product including, as ingredients, tofu, water-soluble dietary fibers derived from grain, and gluten.
[9] The meat-like food product as described in [8], in which the water-soluble dietary fibers derived from grain are those of at least one selected from the group consisting of oat bran, barley, and rye.
[10] The meat-like food product as described in [8] or [9], in which the meat-like food product is a fried chicken-like food product.

### BRIEF DESCRIPTION OF THE DRAWING

FIG. 1 is a graph showing the results of hardness measurement performed on the meat-like food products according to examples and a comparative example.

### DESCRIPTION OF PREFERRED EMBODIMENTS

The following definitions apply in the present specification.

“Solid content” refers to the mass ratio of a solid component to the total mass of a sample, and is a value calculated by the following equation (1):

Solid content (mass %)=100−moisture content (mass %) (1)

The “moisture content” refers to a value as measured by an atmospheric heating/drying method (drying aid addition method). In particular, 1 g of a sample is dried at 100±1° C. to obtain the mass of the sample after drying, and the moisture content is determined by the following equation (2):

Moisture content (mass %)={(mass of the sample before drying−mass of the sample after drying)/mass of the sample before drying}×100 (2)

The moisture content of dry powder or a oil or fat as an ingredient is herein regarded as zero.

Unless otherwise indicated, any numerical range expressed using “to” herein refers to a range which includes numerical values before and after “to” as the lower and upper limits.

### <Ingredients>

In an embodiment of the present application, the ingredients for the meat-like food product comprise tofu, water-soluble dietary fibers derived from grain, and gluten. The tofu serves as a main protein source. The water-soluble dietary fibers derived from grain and the gluten each function as a binder and facilitate rounding of dough. In particular, the water-soluble dietary fibers derived from grain are excellent in the effect of enhancing the shapability of the dough. The combination of tofu, the water-soluble dietary fibers derived from grain, and gluten contributes to the meat-like texture of the food product.

The tofu includes shaped tofu obtained by coagulating soy milk with brine, tofu puree obtained by grinding a coagulate formed by adding brine to soy milk, etc. Examples of the shaped tofu include silken tofu, firm tofu, and filled tofu. While such tofus can be used without any particular limitation, it is preferred to use tofu puree because it can be easily mixed with other materials.

Either a single type of tofu, or a combination of two or more types of tofu may be used.

The tofu, which is produced using soy milk squeezed from soybeans, differs from soy flour produced by grinding soybeans.

A commercially available product(s) may be used as the tofu. Alternatively, the tofu may be produced by a known method.

In the present specification, the tofu puree refers to a product obtained by adding brine to soy milk to form a coagulate, and grinding the coagulate into a semi-liquid state. The tofu puree, which is not shaped, differs from shaped tofu such as silken tofu, firm tofu, or filled tofu.

The tofu puree can be produced, for example, by the method disclosed in International Publication No. WO 1999/35920.

In particular, the tofu puree can be produced by adding a coagulant to soy milk, holding the mixture at 40 to 90° C. to form a coagulate, grinding the coagulate, cooling the ground product to 10 to 35° C., and further grinding the ground product to an average particle size of 2 to 15 μm and a 90% particle size of not more than 35 μm.

The tofu puree preferably has the following physicochemical properties a) to d):

a) its viscosity is 20 to 3,000 mPa·s;
b) its dynamic storage modulus is 0.2 to 600 Pa;
c) its dynamic loss modulus is 0.2 to 250 Pa; and
d) particles contained in the tofu puree have an average particle size of 2 to 15 μm and a 90% particle size of not more than 35 μm.

Here, the “viscosity” is measured by using a B-type viscometer (e.g., DV L-BII, manufactured by Tokimec, Inc.) equipped with a No. 2 or No. 4 rotor, and rotating the rotor at 60 rpm after allowing the tofu puree to stand at 10° C. for 24 hours.

The “dynamic storage modulus” and “dynamic loss modulus” are measured at a frequency of 50.0 rad/s using an ARES viscoelasticity measuring system (e.g., ARES viscoelasticity measuring system, manufactured by Rheometrics Scientific F.E. Ltd.) after allowing the tofu puree to stand at 10° C. for 24 hours.

The “average particle size”, i.e. the diameter of a particle corresponding to 50% of a volume-basis cumulative particle distribution, and the “90% particle size”, i.e. the diameter of a particle corresponding to 90% of the volume-basis cumulative particle distribution, are measured using a laser-diffraction particle size distribution measuring apparatus (LA-500, manufactured by Horiba, Ltd.) after allowing the tofu puree to stand at 10° C. for 24 hours.

The solid content of the tofu for use in the preparation of the dough is preferably 3.0 to 18% by mass, more preferably 5.0 to 15% by mass, and even more preferably 5.2 to 12% by mass.

The water-soluble dietary fibers derived from grain refer to water-soluble dietary fibers contained in seeds of a gramineous plant. A grain material containing water-soluble dietary fibers, for example, can be used as the water-soluble dietary fibers derived from grain. While there is no particular limitation on the grain material, it is preferably at least one selected from the group consisting of oat bran, barley, and rye. The grain material preferably comprises at least oat bran. The oat bran refers to hulls of oat which is a plant belonging to the genus Avena of the grass family. The grain material preferably contains water-soluble dietary fibers as a main component, and may contain other component(s).

The solid content of the water-soluble dietary fibers derived from grain for use in the preparation of the dough is preferably more than 6.4% by mass and less than 48.5% by mass, more preferably 8 to 45% by mass, even more preferably 15 to 45% by mass, and still more preferably 19 to 40% by mass.

Gluten is a protein generated from grain endosperm and can be exemplified by wheat gluten, barley gluten, and rye gluten. It is to be noted that gluten contained in the “grain material containing water-soluble dietary fibers” is excluded from the gluten described in the present specification. Modified gluten, which has been treated by a known method, can also be used. It is preferred to use gluten derived from wheat.

The solid content of gluten for use in the preparation of the dough is preferably more than 0% by mass and less than 24.7% by mass, more preferably 0.1 to 23% by mass, even more preferably 1 to 20% by mass, still more preferably 2 to 17% by mass, and yet more preferably 2.8 to 16.5% by mass.

The water-soluble dietary fibers derived from grain and the gluten are preferably used in the form of dry powder.

The ingredients for the meat-like food product may also include at least one (hereinafter also referred to as the ingredient A) selected from the group consisting of corn flour, konjac, brown rice flour, potato flakes, pea flour, and soy flour. The ingredient A contributes to an increase in the solid content and to an adjustment of the texture and properties of the food product.

The corn flour, brown rice flour, potato flakes, pea flour, and soy flour are preferably used in the form of dry powder.

The solid content of the konjac for use in the preparation of the dough is preferably 3.0 to 12.0% by mass, more preferably 5.0 to 7.0% by mass, and even more preferably 5.5 to 5.7% by mass. The konjac is preferably used in the form of cut or ground particles having an equivalent volume diameter of 5.0 to 7.0 mm. There is no particular limitation on the shape of each particle. The particle shape may be, for example, cubic, cuboid or spherical. The use of frozen konjac whose moisture is in a frozen state is preferred because of easy release of water during a heating step and the high effect of enhancing the juicy texture of the food product.

The ingredients for the meat-like food product may also include a fat or oil which is liquid at room temperature. The “room temperature” herein refers to a temperature range of 20° C.±1.5° C. The fat or oil contributes to enhancement of the juicy texture of the food product.

The fat or oil is preferably a vegetable oil. Examples of the vegetable oil include soybean oil, rapeseed oil, corn oil, cottonseed oil, rice oil, olive oil, and a mixed vegetable oil (which may be a salad oil) including a mixture of two or more of these oils. Such fats or oils may be used either singly or in a combination of two or more.

The ingredients for the meat-like food product may also include an ingredient(s) other than the above-described ingredients.

Examples of such other ingredients include seasonings such as sugars, a sweetener other than sugars, salt, vinegar, an alcoholic liquor, soy sauce, and sweet sake; and spices such as ginger, garlic, cumin, coriander, cinnamon, allspice, and zanthoxyli fructus. Such other ingredients may be used either singly or in a combination of two or more.

### <Meat-Like Food Product Production Method>

### First Embodiment

In the production method of this embodiment, the ingredients for the meat-like food product are first mixed to prepare a dough (this step will be referred to as the dough preparation step).

The dough includes at least tofu, the water-soluble dietary fibers derived from grain, and gluten, and is a viscoelastic mixture obtained by evenly mixing these ingredients. The dough may be a mixture comprising tofu, the water-soluble dietary fibers derived from grain, gluten, the ingredient A, a liquid fat or oil, a seasoning(s), a spice(s), and moisture. The dough may also be a mixture comprising at least tofu, the water-soluble dietary fibers derived from grain, and gluten, and containing no water-insoluble dietary fibers derived from grain.

Water-soluble dietary fibers derived from grain/tofu (in terms of solid content), which indicates the mass ratio of the solid content of the water-soluble dietary fibers derived from grain to the solid content of tofu, is more than 0 and not more than 20, preferably 0.1 to 20, more preferably 1 to 15, even more preferably more than 1.2 and less than 8.9, still more preferably 1.5 to 8.5, yet more preferably 3 to 7.5, yet more preferably 3.5 to 7.4, and especially preferably 3 to 4. The effect of imparting meat-like texture is high when the water-soluble dietary fibers derived from grain/tofu (in terms of solid content) is within the above range. The water-soluble dietary fibers derived from grain/tofu (in terms of solid content) can also be reworded as the ratio of the total mass of the solid content of the water-soluble dietary fibers derived from grain to the total mass of the solid content of tofu.

Gluten/tofu (in terms of solid content), which indicates the mass ratio of the solid content of gluten to the solid content of tofu, is more than 0 and less than 4.5, may be more than 1.2 and less than 2.1, or may be 0.1 to 4.0, preferably not less than 0.5 and less than 4.5, more preferably 0.5 to 3, even more preferably 0.5 to 2.5, still more preferably 1 to 2.5, yet more preferably 1 to 2, and yet more preferably 1.3 to 1.8. The effect of imparting meat-like texture is high when the gluten/tofu (in terms of solid content) is within the above range. The gluten/tofu (in terms of solid content) can also be reworded as the ratio of the total mass of the solid content of gluten to the total mass of the solid content of tofu.

When the ingredient A, which is at least one selected from the group consisting of corn flour, konjac, brown rice flour, potato flakes, pea flour, and soy flour, is used, the ingredient A/tofu (in terms of solid content), which indicates the mass ratio of the solid content of the ingredient A to the solid content of tofu, is preferably more than 1.2 and less than 2.3, may be more than 1.2 and less than 2.1, preferably 1.3 to 2, more preferably 1.3 to 1.9, and even more preferably 1.3 to 1.8. The ingredient A/tofu (in terms of solid content) can also be reworded as the ratio of the total mass of the solid content of the ingredient A to the total mass of the solid content of tofu.

When konjac is used, konjac/tofu (in terms of solid content), which indicates the mass ratio of the solid content of konjac to the solid content of tofu, is preferably not less than 0.1, more preferably not less than 0.2, and even more preferably not less than 0.3. On the other hand, the konjac/tofu (in terms of solid content) is preferably not more than 1, more preferably less than 0.89, and even more preferably not more than 0.7. The upper limit values and the lower limit values of the konjac/tofu (in terms of solid content) can be combined arbitrarily. The konjac/tofu (in terms of solid content) can also be reworded as the ratio of the total mass of the solid content of konjac to the total mass of the solid content of tofu.

From the viewpoint of flavor, the content of soy flour is preferably not more than 10% by mass, more preferably not more than 5% by mass, and even more preferably not more than 1% by mass based on the total amount of the ingredients. The content of soy flour may be 0% by mass of the total amount of the ingredients.

When a fat or oil which is liquid at room temperature is used as an ingredient of the meat-like food product, the fat or oil/the solid content of tofu, which indicates the mass ratio of the fat or oil to the solid content of tofu, is preferably 0.1 to 5, more preferably 0.2 to 4, and even more preferably 0.2 to 2. The fat or oil/the solid content of tofu can also be reworded as the ratio of the total mass of the fat or oil to the total mass of the solid content of tofu.

The moisture content of the dough is preferably adjusted to a range that facilitates shaping of the dough. For example, the total solid content of the dough, i.e. the sum of the solid contents of all the ingredients, is preferably 5 to 30% by mass, more preferably 8 to 25% by mass, even more preferably 10 to 20% by mass, and still more preferably 15 to 20% by mass. The sum of the solid contents of all the ingredients is the proportion of the total mass of the solid content of all the ingredients to the total mass of the dough.

In the dough preparation step, all the ingredients are mixed uniformly to obtain a dough. The above-described other ingredients, such as seasonings, are preferably pre-mixed to prepare a seasoning liquid.

The ingredients are preferably mixed in the following order. First, tofu and a liquid ingredient(s) are mixed. The liquid ingredient(s) is, for example, a fat or oil, or a seasoning(s). Subsequently, the water-soluble dietary fibers derived from grain are added to and mixed with the mixture to obtain a mixed liquid. When the ingredient A is used, it is preferably added simultaneously with the water-soluble dietary fibers derived from grain. Subsequently, gluten is added to the mixed liquid, and the mixture is mixed to obtain the dough. In order to increase the viscoelasticity, the mixed liquid is preferably allowed to stand after the addition of gluten and before the mixing of the mixture, thereby causing the gluten to swell. For example, the standing time is preferably 10 to 60 minutes, more preferably 20 to 30 minutes.

Next, the dough is shaped into a shaped product (this step will be referred to as the shaping step), and the shaped product is heated to obtain a meat-like food product (this step will be referred to as the heating step).

The shaping step and the heating step can be performed by a method which is known in the field of food production using meat as an ingredient. There is no particular limitation on the shape of the shaped product. The shape can be appropriately selected depending on the intended meat-like food product.

Exemplary heating methods include frying in hot oil, boil heating in hot water, steam heating in high-temperature steam, and oven baking.

A preferable heating method involves frying the shaped product in oil at 160 to 190° C. for 5 to 15 minutes.

The dough preparation step of preparing the dough and the shaping step of shaping the dough may be performed successively. Alternatively, one or more additional steps (hereinafter also referred to as the step I) may be provided between the dough preparation step and the shaping step as long as the step I does not substantially affect the composition and properties of the dough.

The step I may include a step of refrigerating the dough, and a step of freeze-storing the dough and thawing the frozen dough.

The dough preparation step and the shaping step are preferably performed successively from the viewpoint of production quality.

The dough shaping step of shaping the dough and the heating step of heating the shaped product may be performed successively. Alternatively, one or more additional steps (hereinafter also referred to as the step II) may be provided between the shaping step and the heating step as long as the step II does not substantially affect the composition and properties of the dough.

The step II may include a step of refrigerating the shaped product, a step of freeze-storing the shaped product, a step of thawing the frozen shaped product, and a processing step of attaching other material(s) to the shaped product.

The processing step is, for example, a step of attaching a batter to the surface of the shaped product.

From the viewpoint of production efficiency, it is preferable that the shaping step and the heating step are performed successively, or the shaping step, the processing step and the heating step are preferably performed successively.

### Second Embodiment

In the production method of this embodiment, a first dough and a second dough, which differ from each other in composition, are prepared in the dough preparation step. In other words, in the production method of this embodiment, the dough preparation step includes preparing the first dough and also preparing the second dough whose composition differs from that of the first dough, and the shaping step includes wrapping the first dough in the second dough to form a shaped product. A preferable content of each ingredient and the order of addition of the ingredients are the same as those in the above-described first embodiment.

In particular, ingredients for the meat-like food product are mixed with a first composition to prepare the first dough. Separately, ingredients for the meat-like food product are mixed with a second composition to prepare the second dough.

The composition of the first dough and the composition of the second dough are preferably designed so that their textures after heating differ from each other. A difference in composition between the doughs includes a case where there is a difference in the ingredients and a case where the respective doughs include the same ingredients but with different proportions. It is particularly preferred to design the compositions of the first and second doughs so that the first dough after heating has a harder texture than the second dough. For example, when the first dough has a composition containing konjac and the second dough has a composition not containing konjac, the first dough is more likely to harden after heating than the second dough. When the konjac in the first dough is frozen konjac, the first dough is more likely to have a juicy texture after heating than the second dough.

Next, in the shaping step, the first dough is wrapped in the second dough to form a shaped product. Thus, the shaping step includes wrapping the first dough in the second dough to form a shaped product. The term “wrapping” herein means covering 40 to 100% of the surface area of the first dough with the second dough. The manner of wrapping the first dough in the second dough can be appropriately designed so that a meat-like texture can be obtained. The first dough may be entirely covered with the second dough, or part of the first dough may be exposed than the second dough.

In an embodiment, the first dough is shaped into a first intermediate shaped product, and then the first intermediate shaped product is wrapped in the second dough to obtain the intended shaped product.

There is no particular limitation on the mass ratio between the first dough and the second dough which constitute the shaped product. For example, the first dough/the second dough (in terms of solid content), which indicates the mass ratio of the solid content of the first dough to the solid content of the second dough, is preferably 1/10 to 5/1, more preferably 1/2 to 3/1, and even more preferably 4/5 to 2/1. The first dough/the second dough (in terms of solid content) can also be reworded as the ratio of the mass of the solid content of the first dough to the mass of the solid content of the second dough.

There is no particular limitation on the shape of the first intermediate shaped product, the shape of the second dough and the shape of the shaped product as long as the effect of the present invention is not impaired. For example, the first intermediate shaped product can have a ball-like shape, a barrel-like shape, or a flattened shape, or can be in the form of a piece(s) or a strip(s). For example, the second dough can have a sheet-like shape, or can be in the form of a piece(s) or a strip(s). For example, the shaped product can have a ball-like shape, a barrel-like shape, or a flattened shape.

When the second dough in a sheet-like shape is used, the first intermediate shaped product can be formed, for example, in a flattened shape, and the first intermediate shaped product can be wrapped in the second dough to form a ball-like shaped product. When the second dough in the form of pieces or strips is used, the first intermediate shaped product can be formed, for example, in a ball-like shape, and the pieces or strips of the second dough can be attached to the surface of the first intermediate shaped product.

The shaped product can be further wrapped in the first dough, the second dough, or a third dough whose composition differs from those of the first and second doughs.

The coverage proportion of the second dough to the surface area of the first dough can be calculated, for example, in the following manner. An average value of the surface area of the first intermediate shaped product is calculated based on its shape such as a ball-like shape, a barrel-like shape, or a flattened shape, or the form of a piece(s) or a strip(s). Further, the area of contact between the second dough and the first intermediate shaped product is calculated based on the shape of the second dough, such as a sheet-like shape or the form of a piece(s) or a strip(s). The coverage proportion can be calculated by the following equation:

Coverage proportion (%)=(area of contact between the second dough and the first intermediate shaped product)/(surface area of the first intermediate shaped product)×100

Next, the shaped product, obtained in the shaping step, is heated to obtain a meat-like food product (this step will be referred to as the heating step). The heating step and the above-described steps I and II may be performed in the same manner as in the first embodiment.

According to this embodiment, it is possible to produce a meat-like food product in which the texture of the shaped product after heating (also referred to as the heated dough) differs between the central portion and the outer portion. Therefore, it becomes possible to achieve a more complicated texture.

Fox example, in the heated dough, the texture can be made harder and juicier in the central portion than in the outer portion. This can achieve a texture more similar to that of heated chicken thigh.

### <Meat-Like Food Product>

A meat-like food product of a present embodiment is a cooked meat-like food product including, as ingredients, tofu, the water-soluble dietary fibers derived from grain, and gluten. The meat-like food product of this embodiment may be a cooked meat-like food product including a mixture of tofu, the water-soluble dietary fibers derived from grain, gluten, the ingredient A, a liquid fat or oil, a seasoning(s), a spice(s), and moisture. The meat-like food product of this embodiment is preferably a meat-like food product consisting solely of plant ingredients.

The meat-like food product of this embodiment includes at least the heated dough. The meat-like food product of this embodiment may be a heated product of the shaped product comprising the first dough and the second dough having a different composition from the first dough and covering the first dough, described above under the heading [Second Embodiment]. The meat-like food product may be a food product consisting solely of the heated dough, such as a fried chicken-like food product. Alternatively, the meat-like food product may be a food product which, besides the heated dough, includes a heated product of other material(s), such as a batter, which has been attached to the dough in the above-described processing step.

The composition of the heated dough is the same as the composition of the dough before heating except for denaturation of an ingredient(s) due to the heating, a change in the moisture content due to the heating, and absorption of an oil upon frying in the oil.

The absorption of an oil upon frying occurs mainly in a surface layer of the dough. Thus, the composition of a portion, other than the surface layer, of the fried dough can be regarded as being the same as the composition of the dough except for denaturation of an ingredient(s) due to the heating and a change in the moisture content due to the heating.

There is no particular limitation on the type of the meat-like food product of this embodiment. Examples of the food product include a fried chicken-like food product whose texture is similar to that of fried chicken, a chicken fritter-like food product whose texture is similar to that of chicken fritter, a chicken tempura-like food product whose texture is similar to that of chicken tempura, a chicken nugget-like food product whose texture is similar to that of chicken nugget, and a chicken terrine-like food product whose texture is similar to that of chicken terrine. The meat-like food product of this embodiment may be a frozen food product.

The meat-like food product of this embodiment preferably has an appropriate hardness. In particular, the meat-like food product preferably has a maximum load, as measured by the following measuring method, of not less than 796 gf and less than 1911 gf, more preferably more than 897 gf and not more than 1800 gf, and even more preferably 900 gf to 1400 gf.

The measurement of hardness is preformed using a texture analyzer (e.g., product name “TA-XT plus”, manufactured by Eko Instruments Co., Ltd.). An HDP/VB probe is used. A sample is placed on a sample stage, and the probe is brought into contact with the sample. The probe is then lowered vertically at a speed of 1 mm/s. The load [unit: gf] applied to the probe is detected continuously from a point in time when the probe comes into contact with the sample until a point in time when the probe reaches a position corresponding to 80% of the thickness of the sample, and the maximum load is determined.

### EXAMPLES

Hereinafter, the present invention will be described in more detail with reference to Examples, but the present invention is not limited to these Examples.

### <Ingredients>

### (Tofu)

Tofu puree: product name: SOY PUREE, manufactured by Morinaga Milk Industry Co., Ltd., solid content 10.3 mass %

The above-described physicochemical properties a) to d) of the tofu puree, measured by the above-described methods, were as follows: a) the viscosity was 74 mPa·s; b) the dynamic storage modulus was 1.0 Pa; c) the dynamic loss modulus was 0.9 Pa; and d) particles contained in the tofu puree had an average particle size of 4.2 μm and a 90% particle size of 6.8 μm.

Silken tofu: product name: Nama Tofu Kinu, manufactured by Taishi Food Inc., solid content 10.6 mass %

Firm tofu: product name: Nama Tofu Momen, manufactured by Taishi Food Inc., solid content 13.2 mass %

(Water-Soluble Dietary Fibers Derived from Grain)

Oat bran: product name: Organic Oat bran, manufactured by Alishan, dry powder

Rye: product name: Alles Fein, manufactured by Nisshin Flour Milling Inc., fine ground whole rye flour, dry powder

Barley: product name: BARLEYmax Barley Flour (raw flour), manufactured by Teijin Limited, dry powder

Wheat gluten: product name: Wheat Gluten (from France), manufactured by Nippon Garlic Corporation, dry powder

### (Ingredient A)

Corn flour: product name: Corn Flower, manufactured by Tomiz, dry powder

Konjac: product name: Kissuino konjac, manufactured by kanetsu-Bussan Co., Ltd., solid content 10 mass %

### (Other Ingredients)

Salad oil: product name: Nissin Canola Oil, manufactured by The Nisshin OilliO Group, Ltd.

Seasoning liquid: a mixture of soy sauce, sake, salt, sugar, ginger and garlic, solid content 61.5 mass %

### Experiment 1

### Examples 1 to 5

Examples 1 to 5 are examples according to the present application. Fried chicken-like food products were produced with the compositions shown in Table 1 below.

First, tofu, the salad oil, and the seasoning liquid were placed in a bowl, and the mixture was stirred well with a whisk.

Next, the corn flour and the oat bran were added to the mixture, and the mixture was stirred well with a spatula. When the konjac was mixed, the konjac which had been cut into cubic pieces, each having a side length of about 5 mm, and had been frozen in advance was added simultaneously with the oat bran.

Next, the wheat gluten was added to the mixture, and the mixture was allowed to stand for 5 minutes. Thereafter, the mixture was stirred such that all the ingredients were mixed well to obtain a dough.

About 25 g of the each dough obtained was shaped by hand into a ball-like shape.

The shaped product obtained was put into a food oil heated at 160 to 170° C., and fried in the oil for 10 minutes to obtain a fried chicken-like food product.

### Example 6

This example is a comparative example which uses no oat bran. A fried chicken-like food product was produced in the same manner as in Example 2 except for changing the composition as shown in Table 1.

### Example 7

This example illustrates the production of a fried chicken-like food product using a first dough and a second dough.

The first dough was prepared in the same manner as in Example 1 except for using the composition of the first dough shown in Table 1. The first dough obtained was rolled into a sheet with a thickness of 5 mm, and the sheet was frozen. The frozen sheet obtained was cut into plate-like pieces with a length of 2 cm and a width of 1.5 cm (about 3.5 g), as a first intermediate shaped product.

The second dough was prepared in the same manner as in Example 2 except for using the composition of the second dough shown in Table 1. The second dough obtained was divided into pieces each having a weight of about 18 g.

Each second dough piece was rolled into a thickness of about 35 mm. The first intermediate product in a plate-like shape was wrapped in the second dough piece to form a ball-shaped product.

The shaped product obtained was fried in the same manner as in Example 1 to obtain a fried chicken-like food product.

### <Sensory Evaluation>

The fried chicken-like food products obtained in the Examples were subjected to sensory evaluation of their textures.

In particular, three panelists (panelists A to C) who were well-versed in texture evaluation sampled the food products, and rated their “meat-like texture” on a five-point scale according to the following criteria. The following agreement on “meat-like texture” was made in advance between the panelists.

The “meat-like texture” was defined as a texture with such a hardness that when a sample is bitten, it cannot be bitten off at one time and its firmness is non-uniform, and was evaluated comprehensively based on the hardness and the firmness.

The meat-like texture evaluation was made relative to the texture of a commercially available fried chicken-like food product as a reference (rated 3). The average of the scores of the three panelists was calculated. The results are shown in Table 2 below.

The ingredient labeling of the commercially available fried chicken-like food product used as a reference was as follows: “Plant protein, starch, fried oil (vegetable oil), egg white, plant fat or oil, soy sauce, bread crumbs, corn flour, ginger paste, garlic paste, spices, cracker crumbs, sugar, salt, glucose, yeast extract/modified starch, seasonings (amino acid, etc.), (egg, milk components, wheat, soybean, and sesame seeds partly contained)”. The commercially available food product had a strong soy flavor.

### [Evaluation Criteria]

5: superior to the reference
4: slightly superior to the reference
3: equivalent to the reference
2: slightly inferior to the reference
1: inferior to the reference

TABLE 1

| | | | | | | | | | Ex. 7 | |
|---|---|---|---|---|---|---|---|---|---|---|
| | | | | | | | | | First | Second |
| | | | Ex. 1 | Ex. 2 | Ex. 3 | Ex. 4 | Ex. 5 | Ex. 6 | dough | dough |
| Composition | Tofu | Tofu puree | 50.8 | 53.2 | 0 | 0 | 50.8 | 53.2 | 50.8 | 52.2 |
| [mass %] | | Silken tofu | 0 | 0 | 50.8 | 0 | 0 | 0 | 0 | 0 |
| | | Firm tofu | 0 | 0 | 0 | 50.8 | 0 | 0 | 0 | 0 |
| | Oat bran | | 19.2 | 19.2 | 19.2 | 19.2 | 18.0 | 0 | 19.2 | 19.7 |
| | Wheat gluten | | 10.2 | 10.0 | 10.2 | 10.2 | 10.0 | 26.3 | 10.2 | 10.4 |
| | Ingred. A | Corn flour | 9.2 | 9.5 | 9.2 | 9.2 | 7.9 | 12.4 | 9.2 | 9.5 |
| | | Konjac | 2.5 | 0 | 2.5 | 2.5 | 5.2 | 0 | 2.5 | 0 |
| | Fat or oil | Salad oil | 2.1 | 2.1 | 2.1 | 2.1 | 2.1 | 2.1 | 2.1 | 2.2 |
| | Other | Seasoning | 6.0 | 6.0 | 6.0 | 6.0 | 6.0 | 6.0 | 6.0 | 6.0 |
| | ingred. | liquid | | | | | | | | |

| | | | | | | | | |
|---|---|---|---|---|---|---|---|---|
| Total | 100 | 100 | 100 | 100 | 100 | 100 | 100 | 100 |

| | | | | | | | | |
|---|---|---|---|---|---|---|---|---|
| Solid content of tofu [mass %] | 5.23 | 5.48 | 5.38 | 6.71 | 5.23 | 5.48 | 5.23 | 5.38 |
| Solid content of ingred. A [mass %] | 11.45 | 9.5 | 11.45 | 11.45 | 12.58 | 12.4 | 11.45 | 9.5 |
| Total solid content [mass %] | 16.68 | 14.98 | 16.83 | 18.16 | 17.81 | 17.88 | 16.68 | 14.88 |
| Water-soluble dietary fibers derived from | 3.67 | 3.50 | 3.57 | 2.86 | 3.44 | 0 | 3.67 | 3.66 |
| grain/tofu (in terms of solid content) | | | | | | | | |
| Gluten/tofu (in terms of solid content) | 1.95 | 1.82 | 1.89 | 1.52 | 1.91 | 4.80 | 1.95 | 1.93 |
| Ingred. A/tofu (in terms of solid content) | 2.19 | 1.73 | 2.13 | 1.71 | 2.40 | 2.26 | 2.19 | 1.77 |
| Konjac/tofu (in terms of solid content) | 0.43 | 0 | 0.42 | 0.34 | 0.89 | 0 | 0.43 | 0 |
| Fat or oil/solid content of tofu | 0.40 | 0.38 | 0.39 | 0.31 | 0.40 | 0.38 | 0.40 | 0.41 |

TABLE 2

| | | Ref. | Ex. 1 | Ex. 2 | Ex. 3 | Ex. 4 | Ex. 5 | Ex. 6 | Ex. 7 |
|---|---|---|---|---|---|---|---|---|---|
| Score | Panelist A | 3 | 4 | 3 | 4 | 4 | 3 | 1 | 5 |
| [point] | Panelist B | 3 | 4 | 4 | 4 | 4 | 3 | 1 | 5 |
| | Panelist C | 3 | 2 | 2 | 2 | 3 | 3 | 1 | 5 |

| | | | | | | | | |
|---|---|---|---|---|---|---|---|---|
| Average [point] | 3.0 | 3.3 | 3.0 | 3.3 | 3.7 | 3.0 | 1.0 | 5.0 |

The fried chicken-like food products obtained in Example 1 to 5 and Example 7 had a meat-like texture at least equivalent to that of the reference. The fried chicken-like food product of Example 7, which uses a combination of the two types of dough, was especially excellent in meat-like texture.

On the other hand, the fried chicken-like food product of Example 6, which uses no oat bran, had an insufficient meat-like texture. In addition, it was difficult to shape the dough of Example 6 into a ball-like shape; the shaped dough had a flat shape.

### Experiment 2

In Experiment 2, some fried chicken-like food products produced in Experiment 1 were evaluated for their hardnesses using a texture analyzer.

The food products of Examples 6 and 7 of Experiment 1, and fried chicken were used as samples. The fried chicken had been produced by cutting chicken into cubic pieces with a side length of about 3.5 cm, placing the pieces into a food oil heated at 160 to 170° C., and frying the pieces in the oil for 10 minutes.

### <Hardness Evaluation Method>

A texture analyzer (product name “TA-XT plus”, manufactured by Eko Instruments Co., Ltd.) was used. An HDP/VB probe was used. A sample was placed on a sample stage, and the probe was brought into contact with the sample. The probe was then lowered vertically at a speed of 1 mm/s. The load [unit: gf] applied to the probe was detected continuously from a point in time when the probe came into contact with the sample until a point in time when the probe reached a position corresponding to 80% of the thickness of the sample.

A higher load value indicates a harder sample. No load is applied to a sample after the probe penetrates the sample, and therefore the load value is 0.

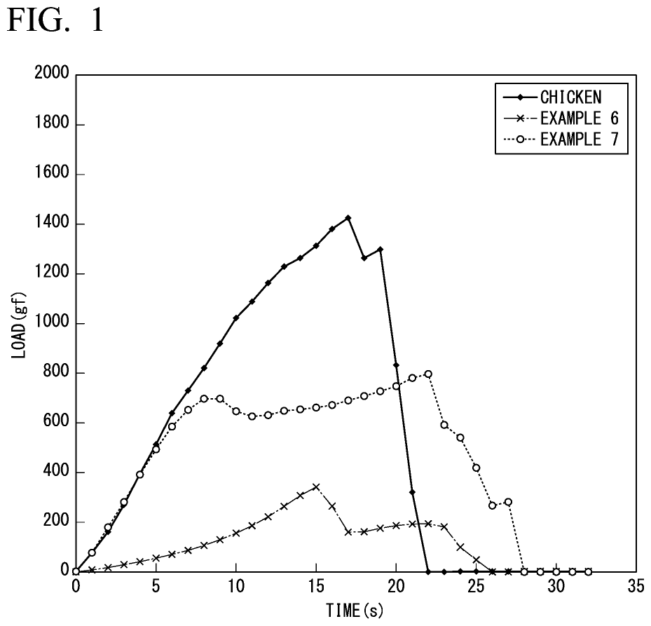

The results are shown in FIG. 1. The time required for the probe to penetrate a sample was 22 seconds for the chicken, 26 seconds for the sample of Example 6, and 28 seconds for the sample of Example 7. The data indicates that compared to the chicken and the food product of Example 6, the fried chicken-like food product of Example 7 took a longer time to bite off and thus was a chewy food product.

The maximum load was 1423 gf for the chicken, 341 gf for the sample of Example 6, and 796 g for the sample of Example 7. The data indicates that the fried chicken-like food product of Example 7 has a hardness which is nearer to that of the chicken than the food product of Example 6 which contains no oat bran.

### Experiment 3

### Examples 8 to 10

In Experiment 3, meat-like food products were produced using different types of water-soluble dietary fibers derived from grain, and their hardnesses were evaluated. Examples 8 to 10 are examples according to the present application. Fried chicken-like food products were produced in the same manner as in Example 1 with the compositions shown in Table 3 below.

### Example 11

This example is a comparative example which uses no water-soluble dietary fibers derived from grain. A fried chicken-like food product was produced in the same manner as in Examples 8 to 10 except for changing the composition as shown in Table 3.

TABLE 3

| | | | Ex. 8 | Ex. 9 | Ex. 10 | Ex. 11 |
|---|---|---|---|---|---|---|
| Composition | Tofu | Tofu puree | 53.2 | 53.2 | 53.2 | 53.2 |
| [mass %] | Water-soluble | Oat bran | 19.2 | 0 | 0 | 0 |
| | dietary fibers | Rye | 0 | 19.2 | 0 | 0 |
| | derived from grain | Barley | 0 | 0 | 19.2 | 0 |
| | Wheat gluten | | 10 | 10 | 10 | 26.3 |
| | Ingred. A | Corn flour | 9.5 | 9.5 | 9.5 | 12.4 |
| | Fat or oil | Salad oil | 2.1 | 2.1 | 2.1 | 2.1 |
| | Other ingred. | Seasoning liquid | 6.0 | 6.0 | 6.0 | 6.0 |

| | | | | |
|---|---|---|---|---|
| Total | 100 | 100 | 100 | 100 |

| | | | | |
|---|---|---|---|---|
| Solid content of tofu [mass %] | 5.48 | 5.48 | 5.48 | 5.48 |
| Solid content of ingred. A [mass %] | 9.5 | 9.5 | 9.5 | 12.4 |
| Total solid content [mass %] | 44.2 | 44.2 | 44.2 | 44.2 |
| Water-soluble dietary fibers derived from | 3.5 | 3.5 | 3.5 | 0 |
| grain/tofu (in terms of solid content) | | | | |
| Gluten/tofu (in terms of solid content) | 1.8 | 1.8 | 1.8 | 4.8 |
| Ingred. A/tofu (in terms of solid content) [mass %] | 1.7 | 1.7 | 1.7 | 2.3 |
| Fat or oil/solid content of tofu [mass %] | 0.38 | 0.38 | 0.38 | 0.38 |
| Maximum load (gf) | 1109 | 1155 | 901 | 897 |

### <Hardness Evaluation Method>

The evaluation of hardness was performed in the same manner as in Experiment 2. The results of the evaluation of hardness for Examples 8 to 11 are shown in Table 3. The results show that the maximum load of the sample of Example 9 which contains rye is equivalent to that of the sample of Example 8 which contains oats bran, and is higher than that of the sample of Example 11 which contains no water-soluble dietary fibers derived from grain. The maximum load of the sample of Example 10 which contains barley is lower than that of the sample of Example 8, but is higher than that of the sample of Example 11.

### Experiment 4

### Examples 12 to 16

In Experiment 4, meat-like food products were produced using different amounts of water-soluble dietary fibers derived from grain, and their hardnesses were evaluated. Examples 13 to 15 are examples according to the present application. Examples 11, 12 and 16 are comparative examples. Fried chicken-like food products were produced in the same manner as in Example 1 with the compositions shown in Table 4 below.

TABLE 4

| | | | Ex. 11 | Ex. 12 | Ex. 13 | Ex. 14 | Ex. 15 | Ex. 16 |
|---|---|---|---|---|---|---|---|---|
| Composition | Tofu | Tofu puree | 53.2 | 61.6 | 53.2 | 44.6 | 39.2 | 33.9 |
| [mass %] | Water-soluble | Oat bran | 0.0 | 6.4 | 19.2 | 32.3 | 40.4 | 48.5 |
| | dietary fibers | | | | | | | |
| | derived from | | | | | | | |
| | grain | | | | | | | |
| | Wheat gluten | | 26.3 | 11.6 | 10.0 | 8.4 | 7.4 | 6.4 |
| | Ingred. A | Corn flour | 12.4 | 11.0 | 9.5 | 8.0 | 7.0 | 6.1 |
| | Fat or oil | Salad oil | 2.1 | 2.4 | 2.1 | 1.8 | 1.5 | 1.3 |
| | Other ingred. | Seasoning | 6.0 | 7.0 | 6.0 | 5.0 | 4.4 | 3.8 |
| | | liquid | | | | | | |

| | | | | | | |
|---|---|---|---|---|---|---|
| Total | 100 | 100 | 100 | 100 | 100 | 100 |

| | | | | | | |
|---|---|---|---|---|---|---|
| Solid content of tofu [mass %] | 5.48 | 5.48 | 5.48 | 5.48 | 5.48 | 5.48 |
| Solid content of Ingred. A [mass %] | 12.4 | 9.5 | 9.5 | 9.5 | 9.5 | 9.5 |
| Total solid content [mass %] | 44.2 | 32.9 | 44.2 | 55.6 | 62.8 | 69.9 |
| Water-soluble dietary fibers derived from | 0 | 1.2 | 3.5 | 5.9 | 7.4 | 8.9 |
| grain/tofu (in terms of solid content) | | | | | | |
| Gluten/tofu (in terms of solid content) | 4.8 | 2.1 | 1.8 | 1.5 | 1.3 | 1.2 |
| Ingred. A/tofu (in terms of solid | 2.3 | 2.0 | 1.7 | 1.5 | 1.3 | 1.1 |
| content)[mass %] | | | | | | |
| Fat or oil/solid content of tofu [mass %] | 0.38 | 0.44 | 0.38 | 0.32 | 0.28 | 0.24 |
| Maximum load (gf) | 897 | 674 | 1109 | 1123 | 1232 | 1911 |

### <Hardness Evaluation Method>

The evaluation of hardness was performed in the same manner as in Experiment 2. The results of the evaluation of hardness for Examples 12 to 16 are shown in Table 4. The results for Example 11 are also shown in Table 4 for reference. The maximum loads were 1109 to 1232 gf, which are preferable values, for the samples of Examples 13, 14 and 15 whose water-soluble dietary fibers derived from grain/tofu (in terms of solid content) values are 3.5, 5.9 and 7.4, respectively. On the other hand, the maximum loads were as low as 674 gf to 897 gf for the samples of Examples 11 and 12 whose water-soluble dietary fibers derived from grain/tofu (in terms of solid content) values are 0 and 1.2, respectively. The maximum load was as high as 1911 gf for the sample of Example 16 whose water-soluble dietary fibers derived from grain/tofu (in terms of solid content) ratio is 8.9; however, the sample cracked and had an insufficient meat-like texture.

### Experiment 5

### Examples 17 to 21

In Experiment 5, meat-like food products were produced using different amounts of wheat gluten, and their hardnesses were evaluated.

Examples 17 to 19 are examples according to the present invention. Examples 20 and 21 are comparative examples. Fried chicken-like food products were produced in the same manner as in Example 1 with the compositions shown in Table 5 below.

TABLE 5

| | | | Ex. 17 | Ex. 18 | Ex. 19 | Ex. 20 | Ex. 21 |
|---|---|---|---|---|---|---|---|
| Composition | Tofu | Tofu puree | 53.2 | 53.2 | 53.2 | 53.2 | 53.2 |
| [mass %] | Water-soluble | Oat bran | 26.4 | 19.2 | 12.7 | 4.5 | 0 |
| | dietary fibers | | | | | | |
| | derived from grain | | | | | | |
| | Wheat gluten | | 2.8 | 10 | 16.5 | 24.7 | 26.3 |
| | Ingred. A | Corn flour | 9.5 | 9.5 | 9.5 | 9.5 | 12.4 |
| | Fat or oil | Salad oil | 2.1 | 2.1 | 2.1 | 2.1 | 2.1 |
| | Other ingred. | Seasoning | 6.0 | 6.0 | 6.0 | 6.0 | 6.0 |
| | | liquid | | | | | |

| | | | | | |
|---|---|---|---|---|---|
| Total | 100 | 100 | 100 | 100 | 100 |

| | | | | | |
|---|---|---|---|---|---|
| Solid content of tofu [mass %] | 5.48 | 5.48 | 5.48 | 5.48 | 5.48 |
| Solid content of ingred. A [mass %] | 9.5 | 9.5 | 9.5 | 9.5 | 12.4 |
| Total. solid content [mass %] | 44.2 | 44.2 | 44.2 | 44.2 | 44.2 |
| Water-soluble dietary fibers derived | 4.8 | 3.5 | 2.3 | 0.8 | 0.0 |
| from grain/tofu (in terms of solid content) | | | | | |
| Gluten/tofu (in terms of solid content) | 0.5 | 1.8 | 3.0 | 4.5 | 4.8 |
| Ingred. A/tofu (in terms of solid content) [mass %] | 1.7 | 1.7 | 1.7 | 1.7 | 2.3 |
| Fat or oil/solid content of tofu [mass %] | 0.38 | 0.38 | 0.38 | 0.38 | 0.38 |
| Maximum load (gf) | 1123 | 1109 | 1079 | 1461 | 897 |

### <Hardness Evaluation Method>

The evaluation of hardness was performed in the same manner as in Experiment 2. The results of the evaluation of hardness for Examples 17 to 21 are shown in Table 5. The maximum loads were 1079 to 1123 gf, which are preferable values, for the samples of Examples 17, 18 and 19 whose gluten/tofu (in terms of solid content) values are 0.5, 1.8 and 3.0, respectively. On the other hand, the maximum load was 1461 gf for the sample of Example 20 whose gluten/tofu (in terms of solid content) value is 0.8. The sample was too hard and not suited for a meat-like food product.

While the present invention has been described with reference to the preferred embodiments thereof, the present invention is not limited to the embodiments. Additions, omissions, replacements, and other modifications can be made to the present disclosure without departing from the spirit or scope of the present invention. The scope of the present invention is not limited by the description given hereinabove and is limited only by the appended claims.

1. A method for producing a meat-like food comprising:
a) preparing a dough by mixing ingredients comprising:
i) tofu,
ii) grain-derived water-soluble dietary fibers, and
iii) gluten;
b) shaping the dough into a shaped meat-like product; and
c) heating the shaped meat-like product.

2. The method for producing a meat-like food according to claim 1, wherein the grain-derived water-soluble dietary fibers are selected from the group consisting of oat bran, barley, rye, and combinations thereof.

3. The method for producing a meat-like food according to claim 1, wherein the ratio of the total mass of solid content of the grain-derived water-soluble dietary fibers to the total mass of solid content of the tofu is not more than 20, and the ratio of the mass of solid content of the gluten to the total mass of the solid content of the tofu is less than 4.8.

4. The method for producing a meat-like food according to claim 1, wherein the ingredients further comprise corn flour, konjac, brown rice flour, potato flakes, pea flour, and/or soy flour.

5. The method for producing a meat-like food according to claim 1, wherein the ingredients further comprise a fat or oil, wherein the fat or oil is liquid at room temperature.

6. The method for producing a meat-like food according to claim 1, wherein the preparing the dough comprises preparing a first dough and preparing a second dough, wherein the second dough ingredients differ from those of the first dough, and wherein the shaping the dough comprises wrapping the first dough in the second dough to form the shaped meat-like product.

7. The method for producing a meat-like food according to claim 1, wherein said heating comprises frying the shaped meat-like product in oil.

8. The method for producing a meat-like food according to claim 2, wherein the ratio of the total mass of solid content of the grain derived water-soluble dietary fibers to the total mass of solid content of the tofu is not more than 20, and the ratio of the mass of solid content of the gluten to the total mass of the solid content of the tofu is less than 4.8.

9. The method for producing a meat-like food according to claim 2, wherein the ingredients further comprise corn flour, konjac, brown rice flour, potato flakes, pea flour, and/or soy flour.

10. The method for producing a meat-like food according to claim 2, wherein the ingredients further comprise a fat or oil, wherein the fat or oil is liquid at room temperature.

11. The method for producing a meat-like food according to claim 2, wherein the preparing the dough comprises preparing a first dough and preparing a second dough, wherein the second dough ingredients differ from those of the first dough, and wherein the shaping the dough comprises wrapping the first dough in the second dough to form the shaped meat-like product.

12. The method for producing a meat-like food according to claim 2, wherein said heating comprises frying the shaped meat-like product in oil.

13. The method for producing a meat-like food according to claim 3, wherein the ingredients further comprise corn flour, konjac, brown rice flour, potato flakes, pea flour, and/or soy flour.

14. The method for producing a meat-like food according to claim 3, wherein the ingredients further comprise a fat or oil, wherein the fat or oil is liquid at room temperature.

15. The method for producing a meat-like food according to claim 3, wherein the preparing the dough comprises preparing a first dough and preparing a second dough, wherein the second dough ingredients differ from those of the first dough, and wherein the shaping the dough comprises wrapping the first dough in the second dough to form the shaped meat-like product.

16. A cooked meat-like food comprising tofu, grain-derived water-soluble dietary fibers, and gluten.

17. The meat-like food according to claim 16, wherein the grain-derived water-soluble dietary fibers are selected from the group consisting of oat bran, barley, rye, and combinations thereof.

18. The meat-like food according to claim 16, wherein the meat-like food is a fried chicken-like food product.

19. The meat-like food according to claim 17, wherein the meat-like food is a fried chicken-like food product.
